(19) United States
(12) Patent Application Publication
(10) Pub. No.: US 2025/0317866 A1
(43) Pub. Date: Oct. 9, 2025

(54) METHOD, USER EQUIPMENT AND BASE STATION

(71) Applicant: NEC Corporation, Tokyo (JP)

(72) Inventor: Caroline LIANG, Guildford (GB)

(73) Assignee: NEC Corporation, Tokyo (JP)

(21) Appl. No.: 19/241,524

(22) Filed: Jun. 18, 2025

Related U.S. Application Data
(62) Division of application No. 17/628,621, filed on Jan. 20, 2022.

(30) Foreign Application Priority Data
Oct. 4, 2019 (GB) 1914396.5

(51) Int. Cl. H04W 52/14; H04W 52/24; H04W 72/23

(52) U.S. Cl. CPC H04W 52/146; H04W 52/248; H04W 72/23

(57) ABSTRACT

In one aspect, a method performed by a user equipment (UE) in a communication network includes: receiving, in a downlink control information (DCI), from a base station, at least one indication, wherein each of the at least one indication indicates that uplink transmission by the UE should be cancelled or paused, and includes a combination of at least one bit representing at least one resource configuration for the uplink transmission; and cancelling or pausing respective uplink transmission in dependence on the at least one resource configuration represented by one of the at least one indication.

This application is a Division of U.S. patent application Ser. No. 17/628,621 filed on Jan. 20, 2022, which is a National Stage Entry of PCT/JP2020/037628 filed on Oct. 2, 2020, which claims priority from Great Britain Patent Application 1914396.5 filed on Oct. 4, 2019, the contents of all of which are incorporated herein by reference, in their entirety.

### TECHNICAL FIELD

The present disclosure relates to a wireless communication system and devices.

### BACKGROUND ART

The present disclosure relates to a wireless communication system and devices thereof operating according to the 3rd Generation Partnership Project (3GPP) standards or equivalents or derivatives thereof. The technology described in this disclosure has particular but not exclusive relevance to improvements relating to enhanced inter-user equipment (UE) transmission (Tx) prioritisation and multiplexing in the so-called ‘5G’ (or ‘Next Generation’) systems. The disclosed improvements have particular, but not exclusive, relevance to Ultra-Reliable and Low-Latency Communications (URLLC) in the context of Enhanced Mobile Broadband (eMBB) transmissions.

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations).

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. mMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency).

During the development of telecommunication technology for 5G/NR there has been discussion of potential enhancements for uplink (UL) inter-UE transmission prioritisation and multiplexing. As part of these discussions UL cancellation schemes and enhanced UL power control schemes have been considered.

UL cancellation schemes involve a UE that is engaged in (pre-emptable) communication (e.g. eMBB communication) in the UL monitoring for an indication (e.g. a ‘cancellation’ indication) from a base station that the UE should pause or stop its UL communication to allow another (‘higher priority’) UE to communicate data having more stringent latency/reliability constraints (e.g. URLLC communications). When such a cancellation indication is identified, the UE engaged in the pre-emptable communication cancels (or pauses) communication to allow the higher priority communication from the other UE to take place without interference. Such multiplexing of URLLC and eMBB transmissions between different UEs can thus provide better spectrum resource utilization and capacity gain.

The enhanced UL power control schemes discussed involve a UE, having data to communicate that has stringent latency/reliability constraints (e.g. URLLC data), boosting its transmission power to transmit that data to ensure that the communication pre-empts any other communication (e.g. eMBB communication) taking place using the same resources.

### SUMMARY OF INVENTION

### Technical Problem

Referring to the UE UL cancellation mechanisms that have been considered as one potential enhancement for UL inter-UE Tx prioritisation and multiplexing, several aspects have been studied, including (inter alia):
various possible indication mechanisms (for example, a UE UL cancellation/pausing indication, a UL continuation indication, a UL re-scheduling indication, and/or the like);
possible physical channel(s) and/or signal(s) to be used for the UL cancellation (or other) indication(s);
the UE processing sequence/timeline for the UL cancellation (or other) indication(s);
the UE monitoring behaviours for the UL cancellation (or other) indication(s);
the UE physical downlink control channel (PDCCH) monitoring capability should the UL cancellation (or other) indication(s) by provided by means of the PDCCH; and
methods to ensure the reliability of the UL cancellation (or other) indication(s) for UE UL cancellation/pausing (and possibly continuation, rescheduling, etc.).

For such UL cancellation mechanisms it is desirable, for reasons of efficiency, to ensure that the requirement for UE monitoring of UL cancellation indications is kept to a minimum and that the size of the UL cancellation indication is restricted as far as reasonably possible.

Referring to the enhanced dynamic power control for boosting URLLC UE power, several aspects have been studied, including (inter alia):
the feasibility of boosting UE power in power limited or interference limited scenarios;
the physical channel/signal used for the signalling;
the UE processing timeline for the signalling;
UE monitoring behaviours for the signalling;
   UE PDCCH monitoring capability if the signalling is by PDCCH; and
methods to ensure the reliability of the signalling.

For such dynamic power control it is desirable, for reasons of efficiency, to ensure that additional signalling and the size of any new signalling parameters is kept to a minimum.

It can be seen, therefore, that there is a need for efficient methods and associated apparatus that support UL cancellation and/or UL power control for enhanced inter-UE multiplexing/prioritisation. Such methods may, for example, include mechanisms for reducing/minimising the necessity for UE monitoring for UL cancellation indications and/or that make efficient use of downlink control signalling for providing UL cancellation indications and/or power control configuration information.

The disclosure aims to provide methods and apparatus that at least partially contribute to addressing the above need.

### Solution to Problem

In one aspect the disclosure provides a method performed by a user equipment (UE) in a communication network, the method comprising: communicating data in an uplink direction; receiving, from a base station, an indication for indicating that the communication in an uplink direction should be cancelled or paused, wherein the indication includes a parameter having a value representing a combination of at least two different resource configurations for uplink communication by at least one further UE; cancelling or pausing communication in an uplink direction in dependence on the plurality of different resource configurations for uplink communication by at least one further UE represented by the parameter provided in the indication for indicating that the communication in an uplink direction should be cancelled or paused.

In one aspect the disclosure provides a method performed by a user equipment (UE) in a communication network, the method comprising: storing mapping data for mapping each of a plurality of possible index values to a different respective transmission power parameter; obtaining uplink data to be communicated in the uplink direction; transmitting, to a base station, a scheduling request for scheduling resources to be used for communicating the uplink data; receiving, from the base station, an indication for use in determining an uplink transmission power to be used for communicating the uplink data, wherein the indication comprises a parameter having one of the plurality of possible index values represented by the mapping data; identifying, based on the mapping data stored at the UE and the received indication, a transmission power to be used for communicating the uplink data; and transmitting the uplink data using the identified transmission power.

In one aspect the disclosure provides a method performed by a user equipment (UE) in a communication network, the method comprising: storing mapping data for mapping each of a plurality of possible index values to a different respective transmission power parameter; communicating uplink data in an uplink direction; receiving, from a base station, an indication for indicating that the communication in an uplink direction should be cancelled or paused, wherein the indication includes a parameter having one of the plurality of possible index values represented by the mapping data; identifying, based on the mapping data stored at the UE and the received indication, a transmission power to be used for communicating the uplink data; and adjusting the transmission power used for transmitting the uplink data based on the identified transmission power.

In one aspect the disclosure provides a method performed by a base station in a communication network, the method comprising: receiving uplink data communicated by a first user equipment (UE) in an uplink direction; receiving from at least one further UE an indication that the at least one further UE has data to transmit that should pre-empt uplink communication by the first UE; and transmitting, to the first UE, an indication for indicating that the communication in an uplink direction by the first UE should be cancelled or paused, wherein the indication includes a parameter having a value representing a combination of at least two different resource configurations for uplink communication by the at least one further UE.

In one aspect the disclosure provides a method performed by a base station in a communication network, the method comprising: storing mapping data for mapping each of a plurality of possible index values to a different respective transmission power parameter; receiving, from a first user equipment (UE), a scheduling request for scheduling resources to be used for communicating uplink data that should pre-empt uplink communication by at least one further UE; transmitting, to at least one of the first UE and the at least one further UE, an indication for use in determining an uplink transmission power to be used for communicating the uplink data, wherein the or each transmitted indication comprises a parameter having one of a plurality of possible index values, and wherein each of the plurality of possible index values represents a different respective transmission power parameter; and receiving, from the or each UE to which a said indication has been transmitted, uplink data that has been transmitted using a transmission power that depends on the transmission power parameter represented by the index value of the parameter provided in the indication sent to that UE.

In one aspect the disclosure provides a user equipment (UE) for a communication network, the UE comprising a controller and a transceiver, wherein the controller is configured: to control the transceiver to communicate data in an uplink direction; to control the transceiver to receive, from a base station, an indication for indicating that the communication in an uplink direction should be cancelled or paused, wherein the indication includes a parameter having a value representing a combination of at least two different resource configurations for uplink communication by at least one further UE; and to control the transceiver to cancel or pause communication in an uplink direction in dependence on the plurality of different resource configurations for uplink communication by at least one further UE represented by the parameter provided in the indication for indicating that the communication in an uplink direction should be cancelled or paused.

In one aspect the disclosure provides a user equipment (UE) for a communication network, the UE comprising a controller and a transceiver, wherein the controller is configured to store mapping data for mapping each of a plurality of possible index values to a different respective transmission power parameter; to obtain uplink data to be communicated in the uplink direction; to control the transceiver to transmit, to a base station, a scheduling request for scheduling resources to be used for communicating the uplink data; to control the transceiver to receive, from the base station, an indication for use in determining an uplink transmission power to be used for communicating the uplink data, wherein the indication comprises a parameter having one of the plurality of possible index values represented by the mapping data; to identify, based on the mapping data stored at the UE and the received indication, a transmission power to be used for communicating the uplink data; and to control the transceiver to transmit the uplink data using the identified transmission power.

In one aspect the disclosure provides a user equipment (UE) for a communication network, the UE comprising a controller and a transceiver, wherein the controller is configured: to store mapping data for mapping each of a plurality of possible index values to a different respective transmission power parameter; to control the transceiver to communicate uplink data in an uplink direction; to control the transceiver to receive, from a base station, an indication for indicating that the communication in an uplink direction should be cancelled or paused, wherein the indication includes a parameter having one of the plurality of possible index values represented by the mapping data; to identify, based on the mapping data stored at the UE and the received indication, a transmission power to be used for communicating the uplink data; and to adjust the transmission power used for transmitting the uplink data based on the identified transmission power.

In one aspect the disclosure provides a base station for a communication network, the base station comprising a controller and a transceiver, wherein the controller is configured: to control the transceiver to receive uplink data communicated by a first user equipment (UE) in an uplink direction; to control the transceiver to receive from at least one further UE an indication that the at least one further UE has data to transmit that should pre-empt uplink communication by the first UE; and to control the transceiver to transmit, to the first UE, an indication for indicating that the communication in an uplink direction by the first UE should be cancelled or paused, wherein the indication includes a parameter having a value representing a combination of at least two different resource configurations for uplink communication by the at least one further UE.

In one aspect the disclosure provides a base station for a communication network, the base station comprising a controller and a transceiver, wherein the controller is configured: store mapping data for mapping each of a plurality of possible index values to a different respective transmission power parameter; to control the transceiver to receive, from a first user equipment (UE), a scheduling request for scheduling resources to be used for communicating uplink data that should pre-empt uplink communication by at least one further UE; to control the transceiver to transmit, to at least one of the first UE and the at least one further UE, an indication for use in determining an uplink transmission power to be used for communicating the uplink data, wherein the or each transmitted indication comprises a parameter having one of a plurality of possible index values, and wherein each of the plurality of possible index values represents a different respective transmission power parameter; and to control the transceiver to receive, from the or each UE to which a said indication has been transmitted, uplink data that has been transmitted using a transmission power that depends on the transmission power parameter represented by the index value of the parameter provided in the indication sent to that UE.

### Advantageous Effects of Invention

According to the present disclosure, it is possible to provide methods and associated apparatus that at least partially contribute to addressing the above need.

### BRIEF DESCRIPTION OF DRAWINGS

Embodiments of the disclosure will now be described, by way of example, with reference to the accompanying drawings in which:

FIG. 1 schematically illustrates a (cellular) telecommunications network;

FIG. 2 is a schematic block diagram illustrating the main components of an eMBB UE of the telecommunications network of FIG. 1;

FIG. 3 is a schematic block diagram illustrating the main components of a URLLC UE of the telecommunications network of FIG. 1;

FIG. 4 is a schematic block diagram illustrating the main components of a base station of the telecommunications network of FIG. 1;

FIG. 5 is a simplified flow diagram illustrating a procedure for indicating a plurality of CG-PUSCH configurations to an eMBB UE in the telecommunications network of FIG. 1; and

FIG. 6 is a simplified flow diagram illustrating a procedure for configuring a power adjustment for a URLLC/eMBB UE in the telecommunications network of FIG. 1.

### DESCRIPTION OF EMBODIMENTS

### Overview

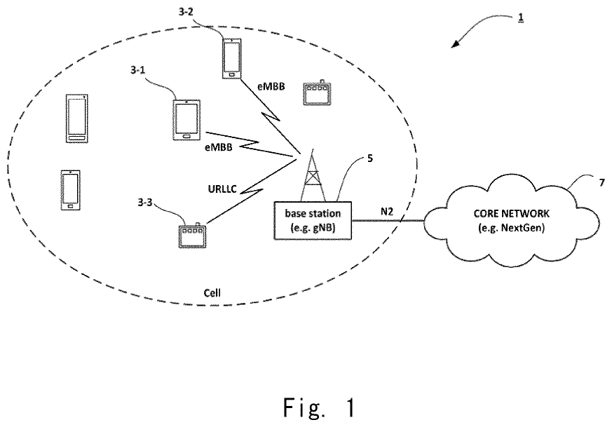

FIG. 1 schematically illustrates a (cellular) telecommunications network 1 in which user equipment 3 (mobile telephones and/or other mobile devices) can communicate with each other via base stations 5 (e.g. a ‘gNB’ in NR networks) using an appropriate radio access technology (RAT). It will be appreciated that in 5G systems base stations are also referred to as comprising one or more transmit receive points (TRPs). As those skilled in the art will appreciate, whilst six UEs and one base station 5 are shown in FIG. 1 for illustration purposes, the system, when implemented, will typically include other base stations and UEs.

Each base station 5 operates one or more associated cells either via a TRP located at the base station (and/or one or more remotely located TRPs). In this example, for simplicity, the base station 5 operates a single cell having an associated system bandwidth. The base station 5 is connected to a core network 7 (e.g. via an appropriate gateway and/or user-plane/control function) and neighbouring base stations are also connected to each other (either directly or via an appropriate base station gateway). The core network 7 may include, amongst other things, a control plane manager entity and a user plane manager entity, one or more gateways (GWs) for providing a connection between the base stations 5 and other networks (such as the Internet) and/or servers hosted outside the core network.

Each UE 3 connects to an appropriate cell (depending on its location and possibly on other factors, e.g. signal conditions, subscription data, capability, and/or the like), for example, by establishing a radio resource control (RRC) connection with the base station 5 operating that cell.

The UEs 3 are configured to receive downlink (DL) control information (DCI—also known as ‘downlink control indicators’) using one or more DL control channels (e.g. one or more physical downlink control channels (PDCCHs)) and to receive DL user data using one or more DL data channels (e.g. one or more physical DL shared channels (PDSCHs)). The UEs 3 are also configured to transmit uplink control information (UCI) such as Hybrid Automated Repeat Request/Acknowledgement feedback (HARQ-ACK), Scheduling Requests (SRs), Channel State Information (CSI) reports, and/or the like using one or more UL control channels (e.g. one or more physical UL control channels (PUCCHs)). Similarly, the UEs 3 are also configured to transmit uplink user data using one or more uplink data channels (e.g. one or more physical uplink shared channels (PUSCHs)). The UEs 3 are also configured for transmitting sounding reference signals (SRS) in the UL direction for use by the base station to estimate UL channel quality over a wider bandwidth.

In order to be able to communicate in the UL on a corresponding PUSCH, the UEs 3 (both URLLC and eMBB) may use dynamically scheduled (or ‘grant-based’) resources or preconfigured grant (‘grant-free’) resources. Dynamically scheduled resources are resources granted by the base station 5 in response to a scheduling request (SR) from the UE 3, and a PUSCH scheduled in such a way may be referred to as a dynamic grant PUSCH (or ‘DG-PUSCH’). Grant-free resources are time/frequency resources that are configured, in advance, for example by means of a PDCCH and may be used by the UE 3 to transmit data, in a contention based manner, without notifying the base station 5 in advance. A PUSCH scheduled in such a way may be referred to as a configured grant PUSCH (or ‘CG-PUSCH’).

The ‘grant-free’ uplink grant and its periodicity may be configured via RRC signalling (which may be referred to as configured grant type 1). The ‘grant-free’ uplink grant may, alternatively, be provided via physical layer (PDCCH) signalling with a periodicity configured by RRC signalling (which may be referred to as configured grant type 2). Both type 1 and type 2 may by supported by the UEs3.

The UEs 3 are also capable of using semi persistent resources for reporting in the uplink on another uplink channel—the semi-persistent PUSCH (or ‘SP-PUSCH’). The eMBB UEs 3-1, 3-2 may transmit using eMBB dedicated time/frequency resources in an eMBB dedicated region of the available communication spectrum (i.e. a region that is not used for other types of communication such as, for example, URLLC transmissions).

The cell(s) of the communication network 1 may include one or more UEs that are specifically configured for Enhanced Mobile Broadband (eMBB) communication in the UL, one or more UEs 3-3 that are specifically configured for Ultra-Reliable and Low-Latency Communications (URLLC) in the UL, and/or one or more UEs that are specifically configured for Massive Machine Type Communications (mMTC) in the UL. In the illustrated example two eMBB configured UEs 3-1, 3-2 are shown engaging in eMBB UL communication, and one URLLC UE 3-3 is shown engaged in URLLC UL communication, although it will be appreciated that there may be other UEs of various types engaging in various types of communication.

The base station 5 and UEs 3 are mutually configured for enhanced inter-UE multiplexing/prioritisation and in particular for inter-UE multiplexing/prioritisation of UL communications between UEs 3-1, 3-2 engaging in eMBB UL communication, and UEs 3-3 engaged in URLLC UL communication. Such multiplexing of URLLC and eMBB transmissions has the potential to provide better spectrum resource utilisation and capacity gains.

Specifically, to protect URLLC transmissions from interfering eMBB transmissions, the base station 5 is configured for providing UL cancellation indications to the UEs 3-1, 3-2 engaging in eMBB UL communication using a given set of time/frequency resources when a URLLC UE 3-3 requires those resources for URLLC UL communication. The base station 5 is also configured to support enhanced power control mechanisms at the URLLC UE(s) 3-3 for the purposes of inter-UE multiplexing/prioritisation.

The UL cancellation indication may be applied in respect of any UL transmissions from an eMMB UE 3-1, 3-2 which do not use the eMBB dedicated region. These may include, for example, PUSCH transmissions (including DG-PUSCH, CG-PUSCH and/or SP-PUSCH transmissions), SRS transmissions and/or PUCCH transmissions (including SR, HARQ and CSI transmissions). It is also possible for the UL cancellation indication to be applied in respect of physical random access channel (PRACH) procedures (e.g. for a preamble and/or Msg 3). It will be appreciated, however, that in the future it may be decided to restrict application of the UL cancellation to certain types of UL transmissions whilst not applying it to other UL transmissions (e.g. UL cancellation may not be specifically applicable for SRS, the PUCCH or a subset of the PUCCH transmission types, PRACH transmissions and/or the like).

A compact DCI is used for the UL cancellation indication provided to the eMBB UEs 3-1, 3-2. The minimum size of the compact DCI is targeted at providing a ten to sixteen bit reduction in size compared to the DCI format size of 40 bits used for the Release 15 fall back DCI, which would support the URLLC block error rate requirements. Advantageously, the UE DCI size budget is not increased by the need to monitoring for the UL cancellation indication.

The base station 5 is configured to provide the UL cancellation indication either in a group common DCI or in a UE specific DCI depending on the number of UEs 3 engaged in (or likely to be engaged in) eMBB uplink communication. If there are a number of eMBB UEs 3-1, 3-2 that would likely be affected by a URLLC transmission, then these UEs 3-1, 3-2 can thus be configured by the base station 5 to monitor a group common DCI which indicates the time/frequency region to which the UL cancellation indication applies. Advantageously, the applicable pre-emptable resource can be indicated via a resource index/bitmap in the UL cancellation indication.

In a beneficial but optional variation of this, the time/frequency region to be used for eMBB/URLLC multiplexing can be pre-configured (or partially pre-configured) to help reduce the number of bits required for the dynamic indication.

It will be appreciated that by indicating the applicable pre-emptable resource in advance and/or by preconfiguring (or partially preconfiguring) the time/frequency region to be used for eMBB/URLLC multiplexing in advance, the eMBB UEs 3.1, 3.2 can beneficially restrict monitoring of the UL cancellation indication to scenarios in which it already has, or is scheduled to have, an UL eMBB transmission over the time and frequency resources configured for the URLLC service. If the time/frequency region of potential URLLC transmission has been pre-informed to the eMBB UEs 3-1, 3-2, then UL cancellation monitoring need only be triggered if an eMBB UE's 3-1, 3-2 eMBB transmission overlaps with the multiplexing regions.

Accordingly, in another beneficial but optional variation, an eMBB UE 3-1, 3-2 is configured to monitor the PDCCH for an UL cancellation indication only if that UE 3-1, 3-2 has, or is scheduled to have, a UL eMBB transmission over resources configured for a URLLC service.

For a UE 3 in a time-division duplex (TDD) mode, the eMBB UE 3-1, 3-2 may transmit uplink traffic on one carrier whilst monitoring for an uplink cancellation indication on another carrier.

For multiplexing between a grant-based UL transmission from a eMBB UE 3-1, 3-2 (e.g. in a DG-PUSCH) and a grant-free UL transmission (e.g. in a CG-PUSCH) from a URLLC UE 3-3, the information of the configured grant resource (e.g. the time-frequency allocation, including periodicity in mini-slots/symbols) for the URLLC services may, beneficially, be provided to the multiplexing eMBB UEs 3-2 via RRC signalling. Where, the eMBB UEs 3-1, 3-2 are, however, scheduled via configured grants (e.g. for transmission via a CG-PUSCH), the time/frequency region over which the UL cancellation applies may then be notified to the eMBB UE(s) 3-1, 3-2 via a resource index in a group common PDCCH (e.g. for multiple UEs) and/or in a UE specific DCI (for fewer UEs or a single UE).

Beneficially, when multiple CG-PUSCHs are active for URLLC UE(s) 3-3, an index (e.g. a ‘resource index’/‘resource configuration index’) having a plurality of different possible values, each of which maps to a respective combination of a plurality of CG-PUSCH configurations is provided, in the UL cancellation indication sent to the eMBB UE(s) 3-1, 3-2, to indicate which CG-PUSCH configurations are active. This allows the multiple CG-PUSCHs configurations to be notified to the eMBB UE(s) 3-1, 3-2 in a particularly efficient manner using a relatively few bits, which is particularly useful given the constraints on the size of the UL cancellation indication. For example, one bit can be used to represent two possible combinations, two bits can be used to represent four possible combinations, three bits can be used to represent eight possible combinations etc. The mapping of the bits of the resource indication to the different configuration combinations may be by any suitable means such as, for example, a mapping table stored in memory of the UEs or some form of mapping function or algorithm. It will be appreciated that not all possible combinations need to be supported, thereby allowing the bit field width to be reduced further.

It will also be appreciated that the resource index, which maps to the combination of a plurality of configured grant configurations, may be configured through RRC signalling (e.g. the mapping table defined).

Referring now to enhanced power control, for dynamically scheduled uplink transmissions (e.g. using a DG-PUSCH), an open-loop parameter set for power control may be indicated to a URLLC UE 3-3 by means of a scheduling DCI for the PUSCH (e.g. using DCI format 0_0 or 0_1) using a separate field than the SRS indication (SRI) field.

Beneficially, the base station 5 and UEs 3 of the communication network 1 are configured to indicate the power control settings for enhanced power control in a particularly efficient manner. Specifically, the base station 5 provides the power control settings for indicating how a URLLC UE 3-3 should adjust its power using an index (e.g. a ‘power indication’ or ‘power adjustment’ index) having a restricted number of bits (two in this example) that is fewer than would otherwise be required to explicitly indicate one of the multiple PUSCH power parameter sets.

In more detail, according to the current technical standards there are thirty possible instances of the power parameter sets represented by the P0-PUSCH-AlphaSet parameters, or 16 instances of the power parameter sets represented by the SRI-PUSCH-PowerControl parameters, that may form part of a PUSCH power configuration provided (e.g. as part the bandwidth part (BWP) configuration) by the base station 5 to the UEs 3. Explicit representation of one of these parameter sets to a UE would thus require four or five bits for the full indication.

Beneficially, therefore, a reduced subset of ‘p0-PUSCH-Alpha’ settings (or SRI-PUSCH-PowerControl) is configured, in advance, in the memory of the URLLC UE(s) 3-3 (e.g. in a look-up table representing only the highest—or a selection at the higher end—of the power setting values). This may be done in any suitable manner for example by means of RRC signalling or the like.

When the URLLC UE 3-3 intends to communicate, therefore, the two bit power adjustment indicator field may be provided, for example in the scheduling DCI (e.g. in DCI Format 0_0 or 0_1), to indicate how the UE 3-3 should adjust its power.

In a variation on this, rather than being an ‘absolute’ indication that is mapped to a specific power parameter set, the two bit power adjustment indicator field may be configured as a ‘relative’ indication to indicate a required change (i.e. increase) in the power settings at the URLLC UE 3-3. For example, the two bit field may indicate an increase in the transmit power setting of 0 dB, 3 dB, 6 dB or 9 dB (or any other suitable power changes). It will be appreciated that both options (absolute and relative) could be supported in given system and used depending on requirements.

It will also be appreciated that alternatively, or additionally, the power adjustment indication could be mapped to value ranges for reducing the eMBB transmission power for eMBB UEs 3-1, 3-2. For example, the power adjustment indication may represent only the lowest—or a selection at the lower end—of the power setting values configured for an eMBB UE 3-1, 3-2. Similarly, the power adjustment indication could be mapped to a relative decrease in the transmit power setting (e.g. 0 dB, 3 dB, 6 dB or 9 dB or any other suitable power changes) for an eMBB UE 3-1, 3-2.

Beneficially, for multiple active CG-PUSCH, the time/frequency region over which an increased power setting may apply can be notified to the URLLC UE(s) via a resource index (e.g. based on mapping to multiple CG-configurations) in the scheduling DCI. This may, for example, be in the same or similar format to the resource index/resource configuration index described above for notifying eMBB UEs of the CG-PUSCH configurations.

A URLLC UE 3-3 may also derive the transmission power based on the time/frequency resource indicated by a group common DCI.

It can be seen, therefore, that the communication network 1 provides for a number of different ways in UL cancellation and/or UL power control may be supported for enhanced inter-UE multiplexing/prioritisation.

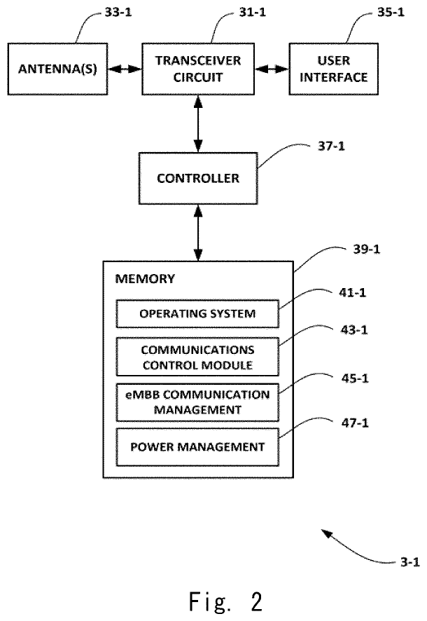

Apparatus in which the beneficial features described above may be incorporated will now be described, by way of example only with reference to FIGS. 2 to 4.

User Equipment (eMBB)

FIG. 2 is a schematic block diagram illustrating the main components of the eMBB UE 3-1 shown in FIG. 1 (e.g. a mobile telephone, smartphone, tablet or other user equipment). It will be appreciated that while the UE 3-1 is described as being in terms of its eMBB capability only, for ease of explanation, the UE 3-1 may be configured for operating as a URLLC UE and/or mMTC UE depending on requirements.

As shown, the UE 3-1 has a transceiver circuit 31-1 that is operable to transmit signals to and to receive signals from a base station 5 via one or more antenna 33-1. The UE 3-1 has a controller 37-1 to control the operation of the UE 3-1 and a user interface 35-1 (e.g. a touch screen/keypad/microphone/speaker and/or the like) for allowing direct control by and interaction with a user. The controller 37-1 is associated with a memory 39-1 and is coupled to the transceiver circuit 31-1. Although not necessarily required for its operation, the UE 3-1 might of course have all the usual functionality of a conventional UE 3 and this may be provided by any one or any combination of hardware, software and firmware, as appropriate. Software may be pre-installed in the memory 39-1 and/or may be downloaded via the telecommunications network or from a removable data storage device (RMD), for example.

The controller 37-1 is configured to control overall operation of the UE 3-1 by, in this example, program instructions or software instructions stored within memory 39-1. As shown, these software instructions include, among other things, an operating system 41-1, a communications control module 43-1, an eMBB management module 45-1, and a power management module 47-1.

The communications control module 43-1 is operable to control the communication between the UE 3-1 and its serving base station(s) 5 (and other communication devices connected to the base station 5, such as further UEs and/or core network nodes). The communications control module 43-1 is configured for handling uplink communications via associated uplink channels (e.g. via a PUCCH and/or a PUSCH) and for handling receipt of downlink communications via associated downlink channels (e.g. via a PDCCH and/or a PDSCH). The communications control module 43-1 is responsible for determining the resources to be used by the UE 3-1 and to determine which bandwidth part (sub-band) is allocated for the UE 3-1 (e.g. based on the bandwidth supported by the transceiver circuit 31-1). It will be appreciated that the supported operating bandwidth (or current operating bandwidth) of the transceiver circuit 31-1 may depend on whether the UE 3-1 operates as a conventional eMBB UE or as a machine-type device for URLLC or mMTC.

The eMBB module 45-1 is responsible for managing the operation of the UE when performing eMBB communication tasks such as high density video streaming or the like.

The power management module 47-1 is responsible for managing power usage by the UE 3-1 including controlling the transmission power based on one or more power configurations received from the base station 5.

### User Equipment (URLCC)

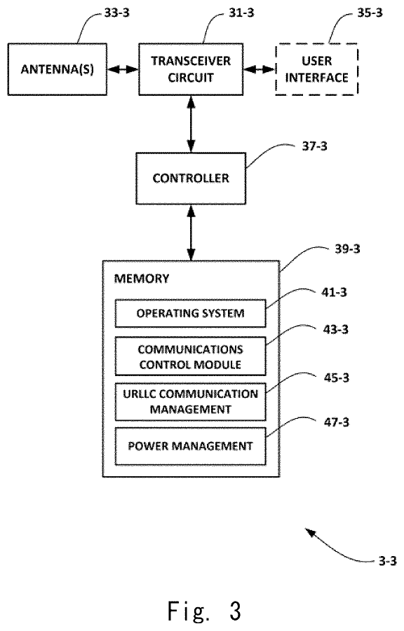

FIG. 3 is a schematic block diagram illustrating the main components of the URLLC UE 3-3 shown in FIG. 1 (e.g. a communication unit of an autonomous vehicle, industrial equipment, a surgical robot or the like, or other user equipment). It will be appreciated that while the UE 3-3 is described as being in terms of its URLLC capability only, for ease of explanation, the UE 3-3 may be configured for operating as an eMBB UE and/or mMTC UE depending on requirements.

As shown, the UE 3-3 has a transceiver circuit 31-3 that is operable to transmit signals to and to receive signals from a base station 5 via one or more antenna 33-3. The UE 3-3 has a controller 37-3 to control the operation of the UE 3-3. The controller 37-3 is associated with a memory 39-3 and is coupled to the transceiver circuit 31-3. Although not necessarily required for its operation, the UE 3-3 might, of course, have all the usual functionality of a conventional UE 3 (e.g. a user interface 35-3, such as a touch screen/keypad/microphone/speaker and/or the like for, allowing direct control by and interaction with a user) and this may be provided by any one or any combination of hardware, software and firmware, as appropriate. Software may be pre-installed in the memory 39-3 and/or may be downloaded via the telecommunications network or from a removable data storage device (RMD), for example.

The controller 37-3 is configured to control overall operation of the UE 3-3 by, in this example, program instructions or software instructions stored within memory 39-3. As shown, these software instructions include, among other things, an operating system 41-3, a communications control module 43-3, a URLLC management module 45-3, and a power management module 47-3.

The communications control module 43-3 is operable to control the communication between the UE 3-3 and its serving base station(s) 5 (and other communication devices connected to the base station 5, such as further UEs and/or core network nodes). The communications control module 43-3 is configured for handling uplink communications via associated uplink channels (e.g. via a PUCCH and/or a PUSCH) and for handling receipt of downlink communications via associated downlink channels (e.g. via a PDCCH and/or a PDSCH). The communications control module 43-3 is responsible for determining the resources to be used by the UE 3-3 and to determine which bandwidth part (sub-band) is allocated for the UE 3-3 (e.g. based on the bandwidth supported by the transceiver circuit 31-3). It will be appreciated that the supported operating bandwidth (or current operating bandwidth) of the transceiver circuit 31-3 may depend on whether the UE 3-3 operates as a conventional URLLC UE (e.g. for critical machine type communication (C-MTC)) or as an eMBB UE or as a machine-type device for mMTC.

The URLLC module 45-3 is responsible for managing the operation of the UE when performing URLLC communication tasks such as vehicle to vehicle (V2V) or vehicle to infrastructure (V2X) communication for autonomous or partially autonomous vehicles, remote medical procedures, safety critical control of industrial equipment, or the like.

The power management module 47-3 is responsible for managing power usage by the UE 3-3 including controlling the transmission power based on one or more power configurations received from the base station 5.

### Base Station

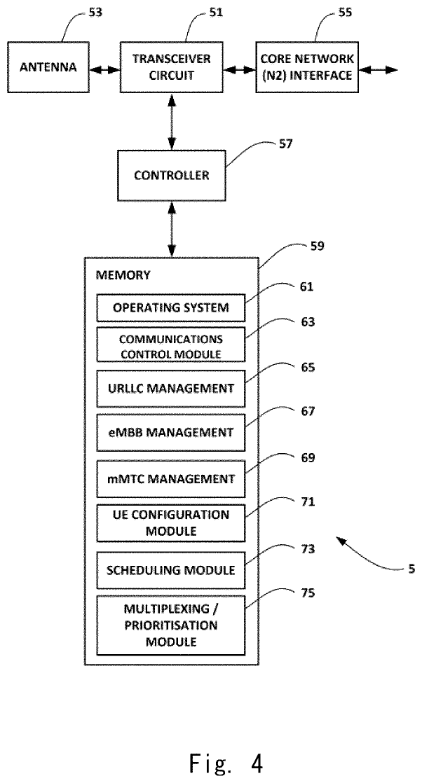

FIG. 4 is a schematic block diagram illustrating the main components of a base station 5 shown in FIG. 1. As shown, the base station 5 has a transceiver circuit 51 for transmitting signals to and for receiving signals from the communication devices (such as UEs 3/user equipment) via one or more antenna 53 (e.g. an antenna array/massive antenna), and a core network interface 55 (referred to as the ‘N2’ interface in NR) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 57 to control the operation of the base station 5. The controller 57 is associated with a memory 59. Software may be pre-installed in the memory 59 and/or may be downloaded via the communications network 1 or from a removable data storage device (RMD), for example. The controller 57 is configured to control the overall operation of the base station 5 by, in this example, program instructions or software instructions stored within memory 59. As shown, these software instructions include, among other things, an operating system 61, a communications control module 63, a URLLC management module 65, an eMBB management module 67, an mMTC management module 69, a UE configuration module 71, a scheduling module 73, and a multiplexing/prioritisation module 75.

The communications control module 63 is operable to control the communication between the base station 5 and UEs 3 and other network entities that are connected to the base station 5. The communications control module 63 also controls the separate flows of downlink user traffic (via associated data radio bearers) and control data to be transmitted to communication devices associated with this base station 5 including, for example, control data for configuring: the way in which the UEs 3 manage their transmission power; the bandwidth parts to be used by the UEs; the location of one or more resources to be used for the (control/data) channels (e.g. within the associated bandwidth part and/or sub-band); and/or the like.

The URLLC management module 65 manages the flows of URLLC data (control and/or user) transmitted to, and received from, the UEs under the overall control of the communications control module 63.

The eMBB management module 67 manages the flows of eMBB data (control and/or user) transmitted to, and received from, the UEs under the overall control of the communications control module 63.

The mMTC management module 69 manages the flows of mMTC data (control and/or user) transmitted to, and received from, the UEs under the overall control of the communications control module 63.

The UE configuration module 71 manages the generation/acquisition of configuration data for configuring the UEs 3, and the transmission of that configuration data to the UEs 3. The configuration data may, for example, comprise parameters for configuring the bandwidth part used at the UEs 3 for the uplink (and/or downlink). The configuration data may, for example, comprise PUSCH power configuration parameters (possibly as part of bandwidth part configuration data for the uplink) including the P0-PUSCH-AlphaSet parameters (such as the p0-PUSCH-AlphaSetId, p0, and alpha parameters) and/or the SRI-PUSCH-PowerControl parameters (such as the sri-PUSCH-PowerControlId, sri-PUSCH-PathlossReferenceRS-Id, sri-P0-PUSCH-AlphaSetId and/or the sri-PUSCH-ClosedLoopIndex).

The scheduling module 73 manages the allocation of time and/or frequency resources for the UEs 3 for their various uplink transmissions (e.g. PUCCH, DG-PUSCH etc.) and downlink receptions (e.g. PDSCH, PDCCH).

The multiplexing/prioritisation module 75 manages the multiplexing and prioritisation of communications between different UEs 3 (i.e. inter-UE communication) including between different UEs 3 that are engaged in different types of communication, for example between URLLC UEs such as 3-3 and eMBB UEs such as UEs 3-1 and 3-2.

In the above description, the UEs 3-1, 3-2, 3-3 and the base station 5 are described for ease of understanding as having a number of discrete modules (such as the communications control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

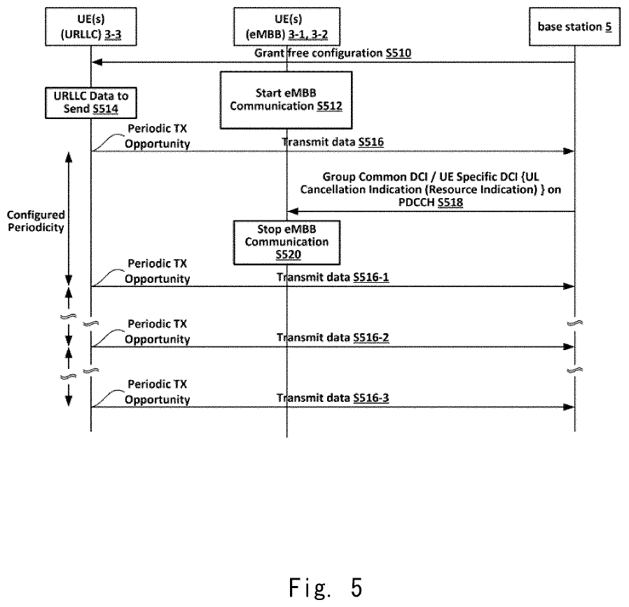

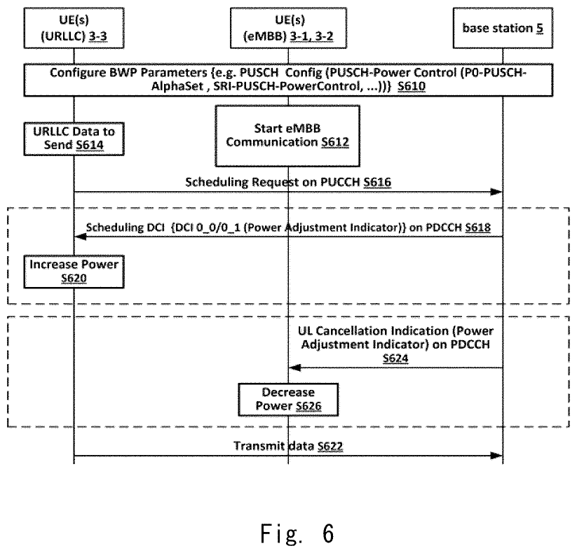

Methods in which some of the beneficial features described above may be incorporated will now be described, by way of example only with reference to FIGS. 5 and 6.

### Operation

FIG. 5 is a simplified flow diagram illustrating a procedure for indicating a plurality of CG-PUSCH configurations to an eMBB UE in an efficient manner when multiple CG-PUSCHs are active for URLLC UE(s) 3-3.

As seen in FIG. 5 the URLLC UE 3-3 is configured with a grant free configuration for the transmission of uplink data in a CG-PUSCH at S510. The eMBB(s) UE 3-1, 3-2 are engaged in eMBB communication (as started at S512).

When the URLLC UE 3-3 has URLLC data to send (at S514) it will start transmission of that data at the next available opportunity (at S516) as indicated by the periodicity in the grant free configuration (possibly with a boosted transmission power in accordance with enhanced power control). In this example it is assumed that there are multiple CG-PUSCHs active for URLLC UE(s) 3-3 at the same time. The base station 5 identifies the multiple active CG-PUSCHs and sends, at S518, an UL cancellation indication to notify any affected eMBB UEs 3-1, 3-2 that eMBB transmission on the active CG-PUSCH resources for the URLLC communication needs to be stopped.

It will be appreciated that whilst the gNB may not know, in advance, when a resource is needed by a URLLC UE, and thus the first cancellation indication may be after the initial detection of a grant free URLLC transmission, this is still beneficial because It allows the eMBB UEs to stop subsequent transmission. This is beneficial, for example, for periodic deterministic traffic, where informing the eMBB UEs to stop subsequent transmissions allows subsequent URLLC transmissions to take place without the risk of interference from eMBB communications from other UEs. In this regard it will be understood that an eMBB UE may carry out its own grant free transmissions.

In a beneficial variation early grant-free detection may be supported, for example provision of advance signalling from the UE using a reference signal (e.g. SRS, or a common demodulation reference signal (DM-RS)), with a permutation of the current/normal scrambling ID that is configured to provide such an indication. The early warning/notification of grant-free transmission may, for example, take place as soon as data is received, but before data processing begins at the URLLC UE.

Similarly, the multiplexing eMBB UEs may support the configuration of UL interference measurement resources, which correspond to the multiple active configured grants (or the resource configuration index) for the early detection of URLLC transmission.

The UL cancellation indication in this example includes an index (e.g. a ‘resource index’/‘resource configuration index’) having a plurality of different possible values, each of which maps to a respective combination of a plurality of CG-PUSCH configurations. The UL cancellation indication including the resource index may be notified to the eMBB UE(s) 3-1, 3-2 in a group common PDCCH (e.g. for multiple UEs) and/or in a UE specific DCI (for fewer UEs or a single UE).

Following receipt of the UL cancellation indication, the affected eMBB UEs 3-1, 3-2 identify the plural configured grant configurations from the resource index, for example, by reference to a mapping table (an example of which is shown in Table 1) and cancel their eMBB communications selectively in the resource regions represented by those configurations.

TABLE 1

| | Multiple CG- |
|---|---|
| Resource Index | configurations |
| 0 | CG-configuration0, |
| | CG-configuration1 |
| 1 | CG-configuration2, |
| | CG-configuration3 |
| 2 | CG-configuration0, |
| | CG-configuration3 |
| 3 | CG-configuration1, |
| | CG-configuration2 |

As long as the URLLC UE 3-3 has URLLC data to send it continues transmission of that data periodically (at S516-1, S516-2, and S516-3) in accordance with the periodicity in the grant free configuration.

FIG. 6 is a simplified flow diagram illustrating a procedure for configuring a power adjustment for a URLLC UE 3-3 (and/or eMBB UE 3-1, 3-2) when a dynamic grant PUSCH (DG-PUSCH) is used.

As seen in FIG. 6 the UEs 3 (both URLLC and eMBB UEs) are configured, at S610, with appropriate bandwidth part parameters including PUSCH configuration parameters comprising PUSCH power control parameters. The PUSCH power control parameters include, for example, P0-PUSCH-AlphaSet parameters and/or SRI-PUSCH-PowerControl parameters.

When the URLLC UE 3-3 has URLLC data to send (at S614) it sends a scheduling request to the base station on a PUCCH at S616 and the base station 5 responds by scheduling the required time/frequency resources and indicating them to the URLLC UE 3-3 using a scheduling DCI at S618. The scheduling DCI is provided with an additional field (information element) for indicating how the URLLC UE 3-3 should adjust its power (e.g. a field in a DCI format 0_0 and/or 0_1). Following receipt of the scheduling DCI, the URLLC UE(s) 3-3 identifies the required power adjustment (if any), for example, by reference to a mapping table (possible examples of which are shown in Tables 2 and 3) and boost transmission power accordingly (if required) at S620 for transmission of the URLLC data at S622.

TABLE 2

| | Power Parameter Set |
|---|---|
| Power Adjustment Index | (higher power sets) |
| 0 | Power Control Parameter Set 1 |
| 1 | Power Control Parameter Set 2 |
| 2 | Power Control Parameter Set 3 |
| 3 | Power Control Parameter Set 4 |

TABLE 3

| Power Adjustment | |
|---|---|
| Index | Power Increase |
| 0 | 0 dB |
| 1 | 3 dB |
| 2 | 6 dB |
| 3 | 9 dB |

Alternatively, or additionally, when the URLLC UE 3-3 sends the scheduling request to the base station 5 at S616, and the base station 5 responds by scheduling the required time/frequency resources and indicating them to the URLLC UE 3-3 using a scheduling DCI at S618, the base station 5 may also provide, at S624 an UL cancellation indication to one or more eMBB UEs 3-1, 3-2. In this example, the UL cancellation indication is provided with an additional field (information element) for indicating that the affected eMBB UE(s) 3-1, 3-2 should adjust transmission power for the eMBB transmissions. Following receipt of the UL cancellation indication, the eMBB UE(s) 3-1, 3-2 identify the required power adjustment (if any), for example, by reference to a mapping table (possible examples of which are shown in Tables 4 and 5) and reduce transmission power accordingly (if required) at S626 before transmission of the URLLC data by the URLLC UE 3-3 at S622.

TABLE 4

| Power Adjustment | Power Parameter Set |
|---|---|
| Index | (lower power sets) |
| 0 | 0 dB |
| 1 | 3 dB |
| 2 | 6 dB |
| 3 | 9 dB |

TABLE 5

| Power Adjustment | |
|---|---|
| Index | Power Decrease |
| 0 | 0 dB |
| 1 | 3 dB |
| 2 | 6 dB |
| 3 | 9 dB |

### Modifications and Alternatives

A detailed embodiment has been described above. As those skilled in the art will appreciate, a number of modifications and alternatives can be made to the above embodiments whilst still benefiting from the disclosure embodied therein.

For example, the base station 5 and UEs 3 of the communication network 1 may be configured to support the use of a UE specific DCI for the UL cancellation indication (where such use may provide efficiency improvements). Similarly, and the base station 5 and UEs 3 of the communication network 1 may be configured to support the reuse the non-pre-empted resources. Specifically, the ratio of resources required for URLLC transmissions is, typically, relatively small, with the associated PUSCH occupying only a relatively small bandwidth of higher power spectral density (PSD). Contrastingly, eMBB transmissions may have a wider bandwidth due to the higher required data rate. When cancellation of the transmissions of a single eMBB UE 3-1, 3-2 (or, possibly, of a relatively low number of such UEs), the UE specific DCI can, beneficially, be used for the UL cancellation indication. Moreover, where the required timeline can be satisfied, the UE specific UL grant for the same transport block may, beneficially, reuse the non-pre-empted resources of the cancelled UL transmission. Similarly, reuse of the non-pre-empted resources by another PUSCH is also supported.

The use of the UE specific DCI can also allow the use of UE-specific beamforming to provide the UL cancellation indication, which has the potential to significantly improve the PDCCH reliability for cell edge UEs. For reasons of efficiency, the UEs 3 need not be required to simultaneously monitor both group-common and UE specific DCI at the same time for UL cancellation indications.

Moreover for scenarios in which the PUSCH may be transmitted with repetitions, the UL cancellation indication may be used to cancel a single (or possibly more than one) impacted repetition, without cancelling all the repetitions of the whole UL transmission. Any cancelled repetition may then be re-attempted. Similarly, only SRS within specifically within an impacted region need to be cancelled (assuming SRS pre-emption is supported).

In another possible but optional variation, the UL cancellation indication can be configured to include a PUCCH resource indicator (e.g. APRI) if required. For example, for dynamically scheduled PUCCHs, the UL Cancellation Indication may beneficially include the PUCCH resource indicator to allow for the fast recovery/relocation of eMBB PUCCH following cancellation. This advantageously helps to avoid multiple eMBB PDSCH retransmissions, for example if an eMBB HARQ-ACK codebook has to be cancelled, and to avoid significant loss of system efficiency. Moreover, since some PUCCHs (such as that for periodic CSI reporting) may not be of as high a priority as others, a PUCCH resource indicator in the UL cancellation indication can be used to override an initial PUCCH configuration for a lower priority PUCCH.

In another possible but optional variation, a configurable time duration is provided in the UL cancellation indication. Specifically, semi-persistent UL transmissions such as PUSCH, PUCCH, SRS, or periodic UL transmissions (including configured grant PUSCH, PUCCH, and/or SRS) can potentially be cancelled by a UL cancellation indication. SRS can be transmitted on non-cancelled symbols within the same slot. However, the URLLC transmission may be of a relatively short interval. It may, therefore, be unnecessary to stop the periodic UL transmissions at all. Moreover, it may be impractical or inefficient to send UL cancellation indication for each semi-persistent transmission instance which may be affected. A UL cancellation indication may apply for time-domain resources corresponding to multiple UL cancellation indication monitoring occasions. Accordingly, by configuring the applicable time duration for in the UL cancellation indication may be beneficial because no additional signalling is then required to notify the UE to resume or restart a suspended eMBB transmission.

For UL transmission with or without an associated PDCCH, a UE may monitor for UL cancellation indications at least at the latest monitoring occasion ending no later than X symbols before the start of the UL transmission (where X is related to UL cancellation indication processing time). The PDCCH monitoring may be based on a reported UE capability for both eMBB and URLLC. The maximum number of non-overlapping control channel elements (CCEs) for channel estimation per PDCCH monitoring span may be the same across different spans within a slot, each span can cover the common search spaces (CSS) and/or UE specific search space (USS). UL cancellation indication monitoring may be included in a PDCCH monitoring capability indication. The number of non-overlapping CCEs, and number of blind decodings for the purpose of the UL cancellation indication monitoring may not need to be separately configured, since the DCI monitoring interval for the UL cancellation indication will be aligned with a mini-slot based eMBB/URLLC scheduling DCI. Only configured aggregation levels may be supported for UL cancellation indication.

In the above embodiments, the base station uses a 3GPP radio communications (radio access) technology to communicate with the UE. However, any other radio communications technology (i.e. WLAN, Wi-Fi, WiMAX, Bluetooth, etc.) can be used between the base station and the UE in accordance with the above embodiments. The above embodiments are also applicable to ‘non-mobile’ or generally stationary user equipment.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

Whilst the base station and UEs have been described as a 5G base station (gNB) and corresponding UEs it will be appreciated that the features described above may be applied to the gNBs and UEs of LTE/LTE-Advanced and other communications technologies.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VOLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

In one example described herein there is described a method performed by a user equipment (UE) in a communication network, the method comprising: communicating data in an uplink direction; receiving, from a base station, an indication for indicating that the communication in an uplink direction should be cancelled or paused, wherein the indication includes a parameter having a value representing a combination of at least two different resource configurations for uplink communication by at least one further UE;
cancelling or pausing communication in an uplink direction in dependence on the plurality of different resource configurations for uplink communication by at least one further UE represented by the parameter provided in the indication for indicating that the communication in an uplink direction should be cancelled or paused.

The indication for indicating that the communication in an uplink direction should be cancelled or paused may be a UL Cancellation Indication. The indication for indicating that the communication in an uplink direction may be provided in one of a group common downlink control information (DCI) and a UE specific DCI.

The method may further comprise storing mapping data for mapping each of a plurality of possible index values to a different respective combination of at least two different resource configurations and wherein the value of the parameter is one of the plurality of possible index values represented by the mapping data. The method may comprise identifying, based on the mapping data stored at the UE and the parameter, each of resource configurations of the combination represented by the value of the parameter. The mapping data may represent a look-up table.

Each of the resource configurations of the combination represented by the value of the parameter may be a resource configuration for a configured grant physical uplink shared channel (CG-PUSCH). Each of the resource configurations of the combination represented by the value of the parameter may be a resource configuration for an active CG-PUSCH.

The UE may be an enhanced mobile broadband (eMBB) UE and the communication in the uplink direction is an eMBB communication. Each at least one further UE may be an ultra-reliable and low-latency communications (URLLC) UE and the uplink communication by the at least one further UE is a URLLC communication.

In one example described herein there is described a method performed by a user equipment (UE) in a communication network, the method comprising: storing mapping data for mapping each of a plurality of possible index values to a different respective transmission power parameter; obtaining uplink data to be communicated in the uplink direction; transmitting, to a base station, a scheduling request for scheduling resources to be used for communicating the uplink data; receiving, from the base station, an indication for use in determining an uplink transmission power to be used for communicating the uplink data, wherein the indication comprises a parameter having one of the plurality of possible index values represented by the mapping data; identifying, based on the mapping data stored at the UE and the received indication, a transmission power to be used for communicating the uplink data; and transmitting the uplink data using the identified transmission power.

The method may further comprise storing power control parameters for a plurality of power control parameter sets for use in controlling transmission power used for transmitting data, and wherein each transmission power parameter represented by the mapping data corresponds to a respective one of the plurality of power control parameter sets.

There may be fewer transmission power parameters represented by the mapping data than power control parameter sets for which power control parameters are stored.

The mapping data may represent transmission power parameters for a subset of the power control parameter sets and wherein each power control parameter set forming part of the subset of the power control parameter sets corresponds to a higher transmission power than at least the majority of power control parameter sets that are not part of the subset. The transmission power parameters represented by the mapping data may include a plurality of possible power control increases.

The indication for use in determining an uplink transmission power may be received in a scheduling downlink control information (DCI). The indication for use in determining an uplink transmission power may be received in a downlink control information (DCI) having a DCI format of 0_0 or 0_1. The method may further comprise receiving, from a base station, a parameter having a value representing a combination of at least two different resource configurations for which the identified transmission power should be used.

The UE may be an ultra-reliable and low-latency communications (URLLC) UE and the uplink data to be communicated in the uplink direction is URLLC data.

In one example described herein there is described a method performed by a user equipment (UE) in a communication network, the method comprising: storing mapping data for mapping each of a plurality of possible index values to a different respective transmission power parameter; communicating uplink data in an uplink direction; receiving, from a base station, an indication for indicating that the communication in an uplink direction should be cancelled or paused, wherein the indication includes a parameter having one of the plurality of possible index values represented by the mapping data; identifying, based on the mapping data stored at the UE and the received indication, a transmission power to be used for communicating the uplink data; and adjusting the transmission power used for transmitting the uplink data based on the identified transmission power.

The UE may be an enhanced mobile broadband (eMBB) UE and the communication in the uplink direction is an eMBB communication.

Various other modifications will be apparent to those skilled in the art and will not be described in further detail here.

Various other modifications will be apparent to those skilled in the art and will not be described in further detail here.

Part of or all the foregoing embodiments can be described as in the following appendixes, but the present disclosure is not limited thereto.

### Supplementary Note 1

A method performed by a user equipment (UE) in a communication network, the method comprising:
communicating data in an uplink direction;
receiving, from a base station, an indication for indicating that the communication in an uplink direction should be cancelled or paused, wherein the indication includes a parameter having a value representing a combination of at least two different resource configurations for uplink communication by at least one further UE; and
cancelling or pausing communication in an uplink direction in dependence on the plurality of different resource configurations for uplink communication by at least one further UE represented by the parameter provided in the indication for indicating that the communication in an uplink direction should be cancelled or paused.

### Supplementary Note 2

The method according to Supplementary Note 1, wherein the indication for indicating that the communication in an uplink direction should be cancelled or paused is a UL Cancellation Indication.

### Supplementary Note 3

The method according to Supplementary Note 1 or 2, wherein the indication for indicating that the communication in an uplink direction is provided in one of a group common downlink control information (DCI) and a UE specific DCI.

### Supplementary Note 4

The method according to any of Supplementary Notes 1 to 3, wherein the method further comprises storing mapping data for mapping each of a plurality of possible index values to a different respective combination of at least two different resource configurations and wherein the value of the parameter is one of the plurality of possible index values represented by the mapping data.

### Supplementary Note 5

The method according to Supplementary Note 4, wherein the method comprises identifying, based on the mapping data stored at the UE and the parameter, each of resource configurations of the combination represented by the value of the parameter.

### Supplementary Note 6

The method according to Supplementary Note 4 or 5, wherein the mapping data represents a look-up table.

### Supplementary Note 7

The method according to any of Supplementary Notes 1 to 6, wherein each of the resource configurations of the combination represented by the value of the parameter is a resource configuration for a configured grant physical uplink shared channel (CG-PUSCH).

### Supplementary Note 8

The method according to Supplementary Note 7, wherein each of the resource configurations of the combination represented by the value of the parameter is a resource configuration for an active CG-PUSCH.

### Supplementary Note 9

The method according to any of Supplementary Notes 1 to 8, wherein the UE is an enhanced mobile broadband (eMBB) UE and the communication in the uplink direction is an eMBB communication.

### Supplementary Note 10

The method according to any of Supplementary Notes 1 to 9, wherein each at least one further UE is an ultra-reliable and low-latency communications (URLLC) UE and the uplink communication by the at least one further UE is a URLLC communication.

### Supplementary Note 11

A method performed by a user equipment (UE) in a communication network, the method comprising:
storing mapping data for mapping each of a plurality of possible index values to a different respective transmission power parameter;
obtaining uplink data to be communicated in the uplink direction;
transmitting, to a base station, a scheduling request for scheduling resources to be used for communicating the uplink data;
receiving, from the base station, an indication for use in determining an uplink transmission power to be used for communicating the uplink data, wherein the indication comprises a parameter having one of the plurality of possible index values represented by the mapping data;
identifying, based on the mapping data stored at the UE and the received indication, a transmission power to be used for communicating the uplink data; and
transmitting the uplink data using the identified transmission power.

### Supplementary Note 12

The method according to Supplementary Note 11, wherein the method further comprises storing power control parameters for a plurality of power control parameter sets for use in controlling transmission power used for transmitting data, and wherein each transmission power parameter represented by the mapping data corresponds to a respective one of the plurality of power control parameter sets.

### Supplementary Note 13

The method according to Supplementary Note 12, wherein there are fewer transmission power parameters represented by the mapping data than power control parameter sets for which power control parameters are stored.

### Supplementary Note 14

The method according to Supplementary Note 13, wherein the mapping data represents transmission power parameters for a subset of the power control parameter sets and wherein each power control parameter set forming part of the subset of the power control parameter sets corresponds to a higher transmission power than at least the majority of power control parameter sets that are not part of the subset.

### Supplementary Note 15

The method according to Supplementary Note 11, wherein the transmission power parameters represented by the mapping data include a plurality of possible power control increases.

### Supplementary Note 16

The method according to any of Supplementary Notes 11 to 15, wherein the indication for use in determining an uplink transmission power is received in a scheduling downlink control information (DCI).

### Supplementary Note 17

The method according to any of Supplementary Notes 11 to 16, wherein the indication for use in determining an uplink transmission power is received in a downlink control information (DCI) having a DCI format of 0_0 or 0_1.

### Supplementary Note 18

The method according to any of Supplementary Notes 11 to 17, wherein the method further comprises receiving, from a base station, a parameter having a value representing a combination of at least two different resource configurations for which the identified transmission power should be used.

### Supplementary Note 19

The method according to any of Supplementary Notes 11 to 18, wherein the UE is an ultra-reliable and low-latency communications (URLLC) UE and the uplink data to be communicated in the uplink direction is URLLC data.

### Supplementary Note 20

A method performed by a user equipment (UE) in a communication network, the method comprising:
storing mapping data for mapping each of a plurality of possible index values to a different respective transmission power parameter;
communicating uplink data in an uplink direction;
receiving, from a base station, an indication for indicating that the communication in an uplink direction should be cancelled or paused, wherein the indication includes a parameter having one of the plurality of possible index values represented by the mapping data;
identifying, based on the mapping data stored at the UE and the received indication, a transmission power to be used for communicating the uplink data; and
adjusting the transmission power used for transmitting the uplink data based on the identified transmission power.

### Supplementary Note 21

The method according to Supplementary Note 20, wherein the UE is an enhanced mobile broadband (eMBB) UE and the communication in the uplink direction is an eMBB communication.

### Supplementary Note 22

A method performed by a base station in a communication network, the method comprising:
receiving uplink data communicated by a first user equipment (UE) in an uplink direction;
receiving from at least one further UE an indication that the at least one further UE has data to transmit that should pre-empt uplink communication by the first UE; and
transmitting, to the first UE, an indication for indicating that the communication in an uplink direction by the first UE should be cancelled or paused, wherein the indication includes a parameter having a value representing a combination of at least two different resource configurations for uplink communication by the at least one further UE.

### Supplementary Note 23

A method performed by a base station in a communication network, the method comprising:
storing mapping data for mapping each of a plurality of possible index values to a different respective transmission power parameter;
receiving, from a first user equipment (UE), a scheduling request for scheduling resources to be used for communicating uplink data that should pre-empt uplink communication by at least one further UE;
transmitting, to at least one of the first UE and the at least one further UE, an indication for use in determining an uplink transmission power to be used for communicating the uplink data, wherein the or each transmitted indication comprises a parameter having one of a plurality of possible index values, and wherein each of the plurality of possible index values represents a different respective transmission power parameter; and
receiving, from the or each UE to which a said indication has been transmitted, uplink data that has been transmitted using a transmission power that depends on the transmission power parameter represented by the index value of the parameter provided in the indication sent to that UE.

### Supplementary Note 24

A user equipment (UE) for a communication network, the UE comprising a controller and a transceiver, wherein the controller is configured: to control the transceiver to communicate data in an uplink direction; to control the transceiver to receive, from a base station, an indication for indicating that the communication in an uplink direction should be cancelled or paused, wherein the indication includes a parameter having a value representing a combination of at least two different resource configurations for uplink communication by at least one further UE; and to control the transceiver to cancel or pause communication in an uplink direction in dependence on the plurality of different resource configurations for uplink communication by at least one further UE represented by the parameter provided in the indication for indicating that the communication in an uplink direction should be cancelled or paused.

### Supplementary Note 25

A user equipment (UE) for a communication network, the UE comprising a controller and a transceiver, wherein the controller is configured to store mapping data for mapping each of a plurality of possible index values to a different respective transmission power parameter; to obtain uplink data to be communicated in the uplink direction; to control the transceiver to transmit, to a base station, a scheduling request for scheduling resources to be used for communicating the uplink data; to control the transceiver to receive, from the base station, an indication for use in determining an uplink transmission power to be used for communicating the uplink data, wherein the indication comprises a parameter having one of the plurality of possible index values represented by the mapping data; to identify, based on the mapping data stored at the UE and the received indication, a transmission power to be used for communicating the uplink data; and to control the transceiver to transmit the uplink data using the identified transmission power.

### Supplementary Note 26

A user equipment (UE) for a communication network, the UE comprising a controller and a transceiver, wherein the controller is configured: to store mapping data for mapping each of a plurality of possible index values to a different respective transmission power parameter; to control the transceiver to communicate uplink data in an uplink direction; to control the transceiver to receive, from a base station, an indication for indicating that the communication in an uplink direction should be cancelled or paused, wherein the indication includes a parameter having one of the plurality of possible index values represented by the mapping data; to identify, based on the mapping data stored at the UE and the received indication, a transmission power to be used for communicating the uplink data; and to adjust the transmission power used for transmitting the uplink data based on the identified transmission power.

### Supplementary Note 27

A base station for a communication network, the base station comprising a controller and a transceiver, wherein the controller is configured: to control the transceiver to receive uplink data communicated by a first user equipment (UE) in an uplink direction; to control the transceiver to receive from at least one further UE an indication that the at least one further UE has data to transmit that should pre-empt uplink communication by the first UE; and to control the transceiver to transmit, to the first UE, an indication for indicating that the communication in an uplink direction by the first UE should be cancelled or paused, wherein the indication includes a parameter having a value representing a combination of at least two different resource configurations for uplink communication by the at least one further UE.

### Supplementary Note 28

A base station for a communication network, the base station comprising a controller and a transceiver, wherein the controller is configured: store mapping data for mapping each of a plurality of possible index values to a different respective transmission power parameter; to control the transceiver to receive, from a first user equipment (UE), a scheduling request for scheduling resources to be used for communicating uplink data that should pre-empt uplink communication by at least one further UE; to control the transceiver to transmit, to at least one of the first UE and the at least one further UE, an indication for use in determining an uplink transmission power to be used for communicating the uplink data, wherein the or each transmitted indication comprises a parameter having one of a plurality of possible index values, and wherein each of the plurality of possible index values represents a different respective transmission power parameter; and to control the transceiver to receive, from the or each UE to which a said indication has been transmitted, uplink data that has been transmitted using a transmission power that depends on the transmission power parameter represented by the index value of the parameter provided in the indication sent to that UE.

It will be appreciated by a person skilled in the art that numerous variations and/or modifications may be made to the present disclosure as shown in the specific embodiments without departing from the spirit or scope of this disclosure as broadly described. The present embodiments are, therefore, to be considered in all respects to be illustrative and not restrictive.

This application is based upon and claims the benefit of priority from United Kingdom patent application No. 1914396.5, filed on Oct. 4, 2019, the disclosure of which is incorporated herein in its entirety by reference.

### REFERENCE SIGNS LIST

1 telecommunications network
3 user equipment
5 base station
7 core network
31 transceiver circuit
33 antenna
35 user interface
37 controller
39 memory
41 operating system
43 communications control module
45 management module
47 power management module
51 transceiver circuit
53 antenna
55 core network interface
57 controller
59 memory
61 operating system
63 communications control module
65 URLLC management module
67 eMBB management module
69 mMTC management module
71 UE configuration module
73 scheduling module
75 multiplexing/prioritisation module

1. A method performed by a mobile device, the method comprising:
storing mapping data between each of a plurality of index values and each of a plurality of transmission power parameter sets;
receiving, from a base station, downlink control information (DCI) including an indication field for determining a transmission power for transmitting uplink data, wherein the indication field indicates one of the plurality of index values and the indication field includes equal to or less than two bits; and
transmitting the uplink data using a transmission power determined from one set of a plurality of the transmission power parameter sets mapped to the one of the plurality of the index values in the mapping data.

2. The method according to claim 1, wherein
the number of transmission powers corresponding to the plurality of the transmission power parameter sets is fewer than the number of transmission powers corresponding to power control parameters stored in the mobile device.

3. The method according to claim 2, wherein
the mapping data represents transmission power parameter sets for a subset of power control parameter sets including the power control parameters, and
each power control parameter set forming part of the subset of the power control parameter sets corresponds to a higher transmission power than at least the majority of power control parameter sets that are not part of the subset.

4. The method according to claim 1, wherein each of the transmission power parameter sets represented by the mapping data includes a plurality of power control increases.

5. The method according to claim 1, wherein the DCI has a DCI format of 0_0 or 0_1.

6. The method according to claim 1, further comprising receiving, from the base station, a parameter having a value representing a combination of at least one resource configurations for which the transmission power should be used.

7. A method performed by a base station, the method comprising:
transmitting, to a mobile device, downlink control information (DCI) including an indication field for determining a transmission power for the mobile device to transmit uplink data, wherein the indication field indicates one of a plurality of index values and the indication field includes equal to or less than two bits; and
receiving, from the mobile device, the uplink data that has been transmitted using a transmission power determined from one set of a plurality of transmission power parameter sets mapped to the one of the plurality of the index values in mapping data between each of the plurality of index values and each of the plurality of the transmission power parameter sets.

8. A mobile device comprising:
at least one memory storing instructions; and
at least one processor configured to process the instructions to:
store mapping data between each of a plurality of index values and each of a plurality of transmission power parameter sets;
receive, from the base station, a downlink control information (DCI) including an indication field for determining a transmission power for transmitting uplink data, wherein the indication field indicates one of the plurality of index values;
transmit the uplink data using a transmission power determined from one set of a plurality of the transmission power parameter sets mapped to the one of the plurality of the index values in the mapping data.

9. A base station comprising:
at least one memory storing instructions; and
at least one processor configured to process the instructions to:
transmit, to a mobile device, downlink control information (DCI) including an indication field for determining a transmission power for the mobile device to transmit uplink data, wherein the indication field indicates one of a plurality of index values and the indication field includes equal to or less than two bits; and
to control the transceiver to receive, from the mobile device, the uplink data that has been transmitted using a transmission power determined from one set of a plurality of transmission power parameter sets mapped to the one of the plurality of the index values in mapping data between each of the plurality of index values and each of the plurality of the transmission power parameter sets.

10. The method according to claim 1, wherein
each of the plurality of transmission power parameter sets includes P0-PUSCH-AlphaSet.

11. The method according to claim 1, wherein
the plurality of index values include at most 4 types of index values.

12. The method according to claim 1, wherein
the number of the plurality of transmission power parameter sets is at most 30.
